(19) United States
(12) Patent Application Publication
(10) Pub. No.: US 2012/0206461 A1
(43) Pub. Date: Aug. 16, 2012

(54) METHOD AND APPARATUS FOR CONTROLLING A SELF-REFRESHING DISPLAY DEVICE COUPLED TO A GRAPHICS CONTROLLER

(76) Inventors: David WYATT, San Jose, CA (US); Michael A. Ogrinc, San Francisco, CA (US); David Matthew Stears, San Jose, CA (US); Thomas E. Dewey, Menlo Park, CA (US); Manish Modi, San Jose, CA (US)

(21) Appl. No.: 13/025,087

(22) Filed: Feb. 10, 2011

(51) Int. Cl. G06T 1/00

(52) U.S. Cl. 345/501

(57) ABSTRACT

A method and apparatus for controlling a self-refreshing display device coupled to a graphics controller are disclosed. A self-refreshing display device has a capability to drive the display based on video signals generated from a local frame buffer in the display device. A graphics controller coupled to the display device may optimally be placed in one or more power saving states when the display device is operating in a panel self-refresh mode. The graphics controller detects one or more progressive levels of idleness in the graphics controller and the pixel data stored in a frame buffer. Based on the detected idleness, the graphics controller signals the display device to enter or exit the panel self-refresh mode and enters a power saving state. When exiting the panel self-refresh mode, the display device and/or graphics controller ensure that the video signals generated by the local controller and the graphics controller are aligned.

### BACKGROUND OF THE INVENTION

### Field of the Invention

The invention relates generally to display systems and, more specifically, to a method and apparatus for controlling a self-refreshing display device coupled to a graphics controller.

### Description of the Related Art

Computer systems typically include some sort of display device, such as a liquid crystal display (LCD) device, coupled to a graphics controller. During normal operation, the graphics controller generates video signals that are transmitted to the display device by scanning-out pixel data from a frame buffer based on timing information generated within the graphics controller. Some recently designed display devices have a self-refresh capability, where the display device includes a local controller configured to generate video signals from a static, cached frame of digital video independently from the graphics controller. When in such a self-refresh mode, the video signals are driven by the local controller, thereby allowing portions of the graphics controller to be turned off to reduce the overall power consumption of the computer system. Once in self-refresh mode, when the image to be displayed needs to be updated, control may be transitioned back to the graphics controller to allow new video signals to be generated based on a new set of pixel data.

One drawback to the approach of driving video signals with two separate controllers is that the video signals generated by the graphics controller may not be synchronized with the video signals generated by the local controller. For example, the local controller may be generating video signals based on a relatively low refresh rate (number of frames per second drawn to the screen), such as 30 Hz, while the graphics controller may generate video signals based on a higher refresh rate, such as 75 Hz. In such a case, the pixel locations associated with the video signals generated by the local controller at a given point in time may not correspond to the pixel locations associated with the video signals generated by the graphics controller at that same point in time. The misalignment of the pixel locations may result in image artifacts displayed on the screen when control for driving the video signals used to drive the display device is transitioned between the local controller and the graphics controller.

First, control for generating the video signals used to drive the display device may be transitioned from the local controller to the graphics controller without regard to the current pixel location being updated by the display device at that point in time. In such a case, a first portion of the video frame based on the video signals generated by the local controller may be displayed in a first portion of the screen and, after the transition, a second portion of the video frame based on the video signals generated by the graphics controller may be displayed in a second portion of the screen. However, because of the misalignment between the pixel locations associated with the video signals generated by the local controller and the graphics controller during the transition, the pixel locations associated with the video signals used to drive the display device for the second portion of the video frame may not correspond to the pixel locations associated with the second portion of the screen.

Second, the transition of control for generating the video signals used to drive the display device from the local controller to the graphics controller may be delayed until the end of the current video frame such that the display device does not combine video signals from two separate sources into a single video frame. However, due to the delay in waiting for the video signals generated by the local controller to reach the end of the current frame, the pixel locations associated with the video signals generated by the graphics controller, after the delay, may not correspond to the pixel locations associated with a first, top portion of the screen. Thus, the display device will only display a second portion of the video frame in a first, top portion of the screen.

In both of the cases described above, the displayed video frame may include a visible image artifact that is distracting and jarring to a viewer. In the first case, the video frame displayed on the screen is a combination of two different video frames, an image artifact commonly referred to as screen tearing. In the second case, only a lower portion of the video frame is displayed on a top portion of the screen. As the foregoing illustrates, what is needed in the art is an improved technique for transitioning the control for generating video signals that drive a display device between a graphics controller and a controller in a self-refreshing display device.

### SUMMARY OF THE INVENTION

One embodiment of the present invention sets forth a method for managing the activity level of a graphics processing unit coupled to a display device configured with self-refreshing capability. The method includes the steps of detecting a first level of idleness associated with display data generated by the graphics processing unit, and, in response to detecting the first level of idleness, causing the display device to enter a self-refresh mode, causing the graphics processing unit to stop generating video signals for display on the display device, and causing the graphics processing unit to enter a power-saving state.

Another embodiment of the present invention sets forth a method for transitioning control for driving a display device from a local controller included in the display device to a graphics processing unit. The method includes the steps of transmitting a panel self-refresh exit request and a first frame of display data to the display device, monitoring the display device for a period of time to detect that the display device has exited a panel self-refresh mode, and, in response to the display device exiting the panel self-refresh mode, transmitting one or more additional frames of display data to the display device for display.

One advantage of the disclosed technique is that the transition of control for generating the video signals used to drive the display device is managed such that the video signals generated by two separate sources are aligned at the point of transition. In so doing, the pixel data represented by the video signals generated by either the graphics controller or the self-refresh controller are consistently displayed at the correct pixel locations of the display device. Consequently, the occurrence of image artifacts in the video frames displayed via the display device is reduced.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2A illustrates a parallel processing subsystem coupled to a display device that includes a self-refreshing capability, according to one embodiment of the present invention;

FIG. 2B illustrates a communications path that implements an embedded DisplayPort interface, according to one embodiment of the present invention;

FIG. 2C is a conceptual diagram of digital video signals generated by a GPU for transmission over communications path, according to one embodiment of the present invention;

FIG. 2D is a conceptual diagram of a secondary data packet inserted in the horizontal blanking period of the digital video signals of FIG. 2C, according to one embodiment of the present invention;

FIG. 3 illustrates communication signals between parallel processing subsystem and various components of computer system, according to one embodiment of the present invention;

FIG. 4 is a state diagram for a display device having a self-refreshing capability, according to one embodiment of the present invention;

FIG. 5 is a state diagram for a GPU configured to control the transition of a display device into and out of a panel self-refresh mode, according to one embodiment of the present invention;

FIG. 6 illustrates a timing diagram for sending a panel self-refresh entry request to a display device, according to one embodiment of the present invention;

FIG. 7 illustrates a timing diagram for sending a panel self-refresh exit request to a display device, according to one embodiment of the present invention;

FIGS. 8A-8B set forth a flowchart of a method for controlling a self-refreshing display device, according to one embodiment of the present invention;

FIGS. 9A-9C are conceptual diagrams of a video frame that illustrate various re-synchronization processes implemented by a display device, according to one embodiment of the present invention;

FIG. 10 sets forth a flowchart of a method for re-synchronizing the video signals generated by GPU with the video signals generated by SRC, according to one embodiment of the present invention;

FIG. 11 sets forth a flowchart of a method for re-synchronizing the video signals generated by GPU with the video signals generated by SRC, according to another embodiment of the present invention;

FIG. 12 sets forth a flowchart of a method for re-synchronizing the video signals generated by GPU with the video signals generated by SRC, according to another embodiment of the present invention; and

FIG. 13 sets forth a flowchart of a method for re-synchronizing the video signals generated by GPU with the video signals generated by SRC, according to another embodiment of the present invention.

### DETAILED DESCRIPTION

In the following description, numerous specific details are set forth to provide a more thorough understanding of the invention. However, it will be apparent to one of skill in the art that the invention may be practiced without one or more of these specific details. In other instances, well-known features have not been described in order to avoid obscuring the invention.

### System Overview

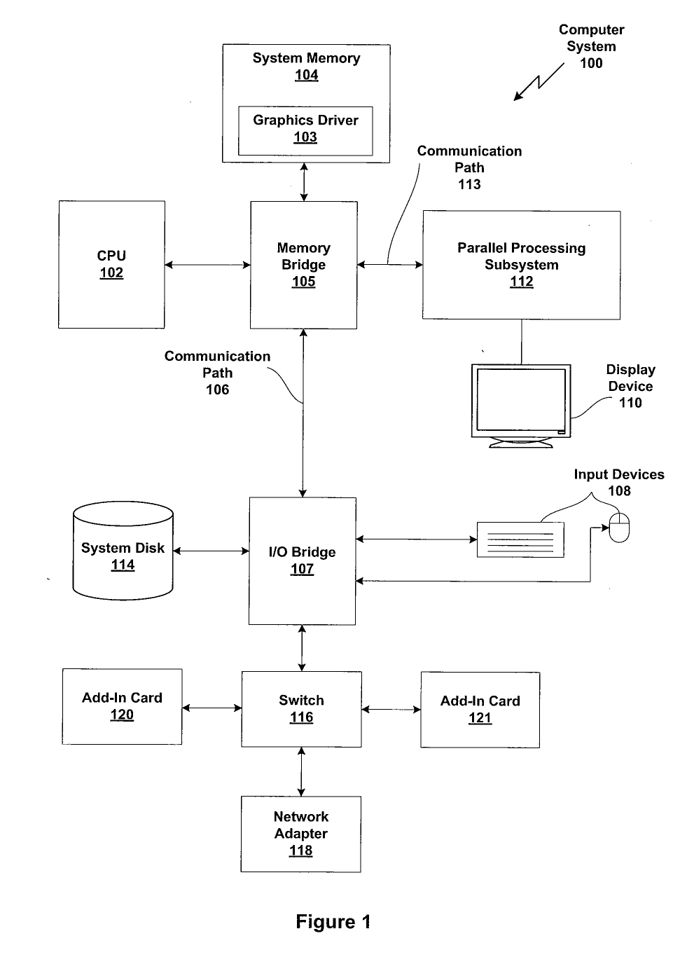

FIG. 1 is a block diagram illustrating a computer system 100 configured to implement one or more aspects of the present invention. Computer system 100 includes a central processing unit (CPU) 102 and a system memory 104 communicating via an interconnection path that may include a memory bridge 105. Memory bridge 105, which may be, e.g., a Northbridge chip, is connected via a bus or other communication path 106 (e.g., a HyperTransport link) to an I/O (input/output) bridge 107. I/O bridge 107, which may be, e.g., a Southbridge chip, receives user input from one or more user input devices 108 (e.g., keyboard, mouse) and forwards the input to CPU 102 via path 106 and memory bridge 105. A parallel processing subsystem 112 is coupled to memory bridge 105 via a bus or other communication path 113 (e.g., a PCI Express, Accelerated Graphics Port, or HyperTransport link); in one embodiment parallel processing subsystem 112 is a graphics subsystem that delivers pixels to a display device 110 (e.g., a conventional CRT or LCD based monitor). A graphics driver 103 may be configured to send graphics primitives over communication path 113 for parallel processing subsystem 112 to generate pixel data for display on display device 110. A system disk 114 is also connected to I/O bridge 107. A switch 116 provides connections between I/O bridge 107 and other components such as a network adapter 118 and various add-in cards 120 and 121. Other components (not explicitly shown), including USB or other port connections, CD drives, DVD drives, film recording devices, and the like, may also be connected to I/O bridge 107. Communication paths interconnecting the various components in FIG. 1 may be implemented using any suitable protocols, such as PCI (Peripheral Component Interconnect), PCI-Express, AGP (Accelerated Graphics Port), HyperTransport, or any other bus or point-to-point communication protocol(s), and connections between different devices may use different protocols as is known in the art.

In one embodiment, the parallel processing subsystem 112 incorporates circuitry optimized for graphics and video processing, including, for example, video output circuitry, and constitutes a graphics processing unit (GPU). In another embodiment, the parallel processing subsystem 112 incorporates circuitry optimized for general purpose processing, while preserving the underlying computational architecture, described in greater detail herein. In yet another embodiment, the parallel processing subsystem 112 may be integrated with one or more other system elements, such as the memory bridge 105, CPU 102, and I/O bridge 107 to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For instance, in some embodiments, system memory 104 is connected to CPU 102 directly rather than through a bridge, and other devices communicate with system memory 104 via memory bridge 105 and CPU 102. In other alternative topologies, parallel processing subsystem 112 is connected to I/O bridge 107 or directly to CPU 102, rather than to memory bridge 105. In still other embodiments, I/O bridge 107 and memory bridge 105 might be integrated into a single chip. Large embodiments may include two or more CPUs 102 and two or more parallel processing systems 112. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

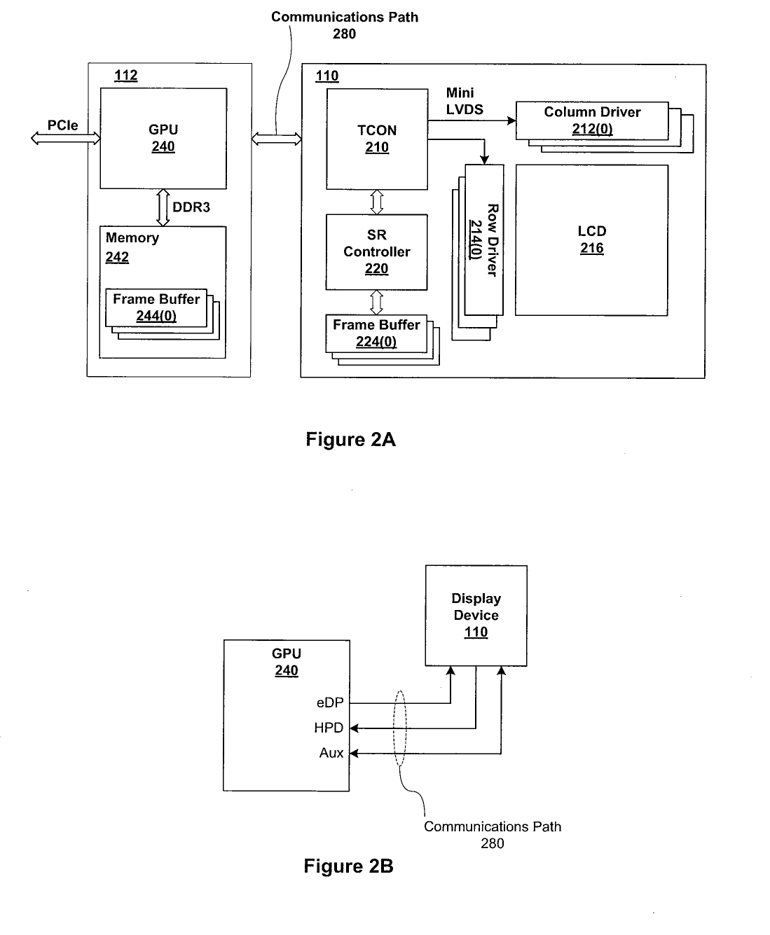

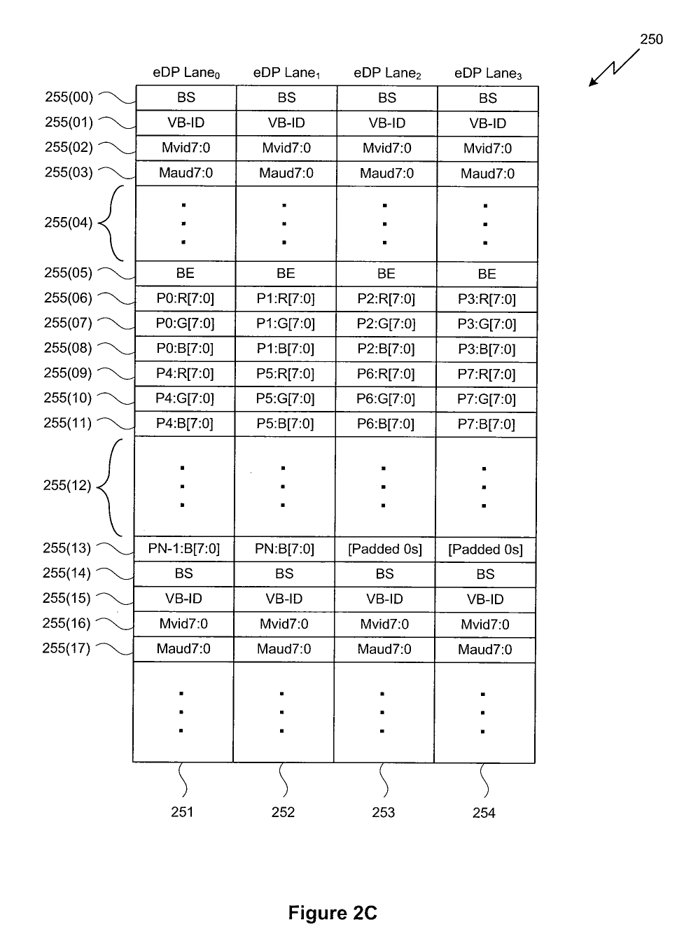

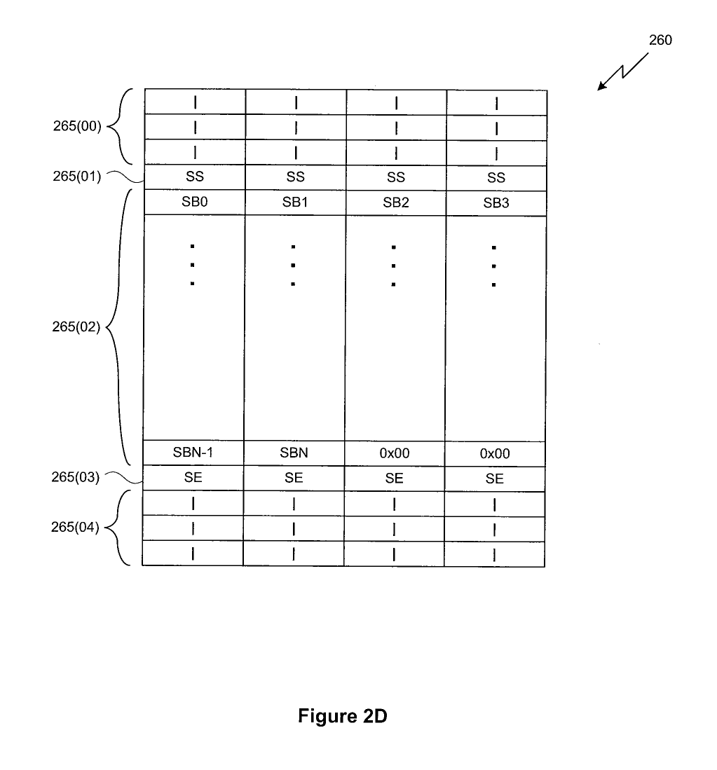

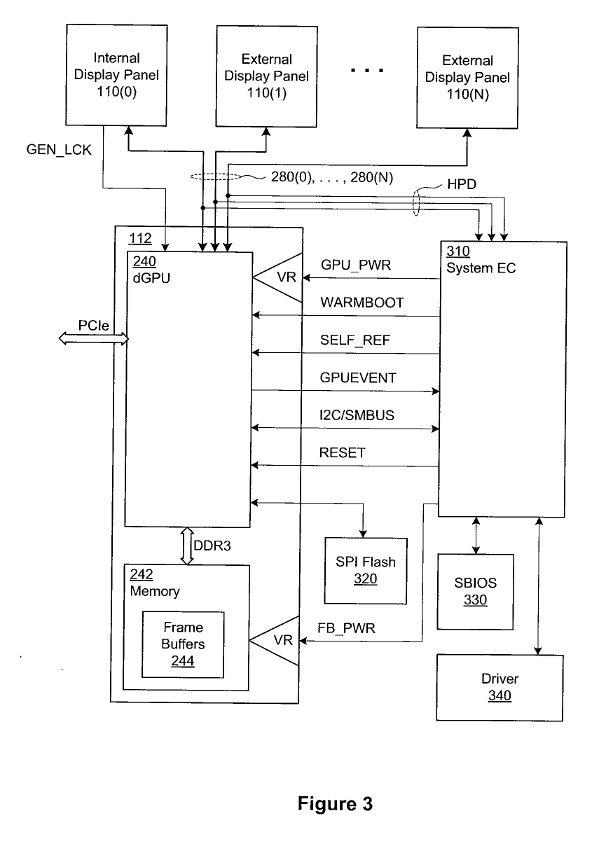

FIG. 2A illustrates a parallel processing subsystem 112 coupled to a display device 110 that includes a self-refreshing capability, according to one embodiment of the present invention. As shown, parallel processing subsystem 112 includes a graphics processing unit (GPU) 240 coupled to a graphics memory 242 via a DDR3 bus interface. Graphics memory 242 includes one or more frame buffers 244(0), 244(1) . . . 244(N-1), where N is the total number of frame buffers implemented in parallel processing subsystem 112. Parallel processing subsystem 112 is configured to generate video signals based on pixel data stored in frame buffers 244 and transmit the video signals to display device 110 via communications path 280. Communications path 280 may be any video interface known in the art, such as an embedded Display Port (eDP) interface or a low voltage differential signal (LVDS) interface.

GPU 240 may be configured to receive graphics primitives from CPU 102 via communications path 113, such as a PCIe bus. GPU 240 processes the graphics primitives to produce a frame of pixel data for display on display device 110 and stores the frame of pixel data in frame buffers 244. In normal operation, GPU 240 is configured to scan out pixel data from frame buffers 244 to generate video signals for display on display device 110. In one embodiment, GPU 240 is configured to generate a digital video signal and transmit the digital video signal to display device 110 via a digital video interface such as an LVDS, DVI, HDMI, or DisplayPort (DP) interface. In another embodiment, GPU 240 may be configured to generate an analog video signal and transmit the analog video signal to display device 110 via an analog video interface such as a VGA or DVI-A interface. In embodiments where communications path 280 implements an analog video interface, display device 110 may convert the received analog video signal into a digital video signal by sampling the analog video signal with one or more analog to digital converters.

As also shown in FIG. 2A, display device 110 includes a timing controller (TCON) 210, self-refresh controller (SRC) 220, a liquid crystal display (LCD) device 216, one or more column drivers 212, one or more row drivers 214, and one or more local frame buffers 224(0), 224(1) . . . 224(M-1), where M is the total number of local frame buffers implemented in display device 110. TCON 210 generates video timing signals for driving LCD device 216 via the column drivers 212 and row drivers 214. Column drivers 212, row drivers 214 and LCD device 216 may be any conventional column drivers, row drivers, and LCD device known in the art. As also shown, ICON 210 may transmit pixel data to column drivers 212 and row drivers 214 via a communication interface, such as a mini LVDS interface.

SRC 220 is configured to generate video signals for display on LCD device 216 based on pixel data stored in local frame buffers 224. In normal operation, display device 110 drives LCD device 216 based on the video signals received from parallel processing subsystem 112 over communications path 280. In contrast, when display device 110 is operating in a panel self-refresh mode, display device 110 drives LCD device 216 based on the video signals received from SRC 220.

GPU 240 may be configured to manage the transition of display device 110 into and out of a panel self-refresh mode. Ideally, the overall power consumption of computer system 100 may be reduced by operating display device 110 in a panel self-refresh mode during periods of graphical inactivity in the image displayed by display device 110. In one embodiment, to cause display device 110 to enter a panel self-refresh mode, GPU 240 may transmit a message to display device 110 using an in-band signaling method, such as by embedding a message in the digital video signals transmitted over communications path 280. In alternative embodiments, GPU 240 may transmit the message using a side-band signaling method, such as by transmitting the message using an auxiliary communications channel. Various signaling methods for signaling display device 110 to enter or exit a panel self-refresh mode are described below in conjunction with FIGS. 2B-2D, 6 and 7.

Returning now to FIG. 2A, after receiving the message to enter the self-refresh mode, display device 110 caches the next frame of pixel data received over communications path 280 in local frame buffers 224. Display device 110 transitions control for driving LCD device 216 from the video signals generated by GPU 240 to video signals generated by SRC 220 based on the pixel data stored in local frame buffers 224. While the display device 110 is in the panel self-refresh mode, SRC 220 continuously generates repeating video signals representing the cached pixel data stored in local frame buffers 224 for one or more consecutive video frames.

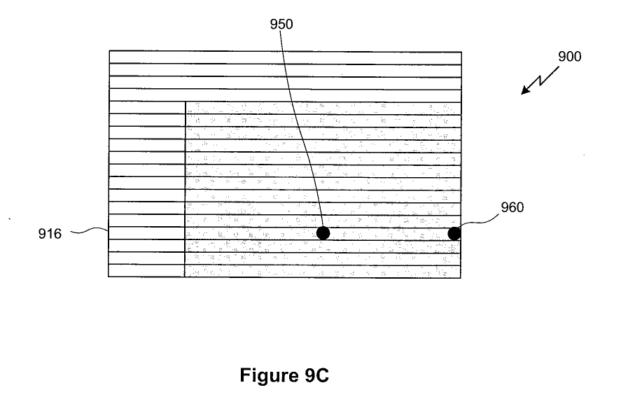

In order to cause display device 110 to exit the panel self-refresh mode, GPU 240 may transmit a similar message to display device 110 using a similar method as that described above in connection with causing display device 110 to enter the panel self-refresh mode. After receiving the message to exit the panel self-refresh mode, display device 110 may be configured to ensure that the pixel locations associated with the video signals generated by GPU 240 are aligned with the pixel locations associated with the video signals generated by SRC 220 currently being used to drive LCD device 216 in the panel self-refresh mode. Various methods for ensuring that the pixel locations are aligned are described below in conjunction with FIGS. 9-13. Once the pixel locations are aligned, display device may transition control for driving LCD device 216 from the video signals generated by SRC 220 to the video signals generated by GPU 240.

The amount of storage required to implement a self-refresh capability may be dependent on the size of the uncompressed frame of video used to continuously refresh the image on the display device 110. In one embodiment, display device 110 includes a single local frame buffer 224(0) that is sized to accommodate an uncompressed frame of pixel data for display on LCD device 216. The size of frame buffer 224(0) may be based on the minimum number of bytes required to store an uncompressed frame of pixel data for display on LCD device 216, calculated as the result of multiplying the width by the height by the color depth of the native resolution of LCD device 216. For example, frame buffer 224(0) could be sized for an LCD device 216 configured with a WUXGA resolution (1920×1200 pixels) and a color depth of 24 bits per pixel (bpp). In this case, the amount of storage in local frame buffer 224(0) available for self-refresh pixel data caching should be at least 6750 kB of addressable memory (1920*1200*24 bpp; where 1 kilobyte is equal to 1024 or 2¹⁰ bytes).

In another embodiment, local frame buffer 224(0) may be of a size that is less than the number of bytes required to store an uncompressed frame of pixel data for display on LCD device 216. In such a case, the uncompressed frame of pixel data may be compressed by SRC 220, such as by run length encoding the uncompressed pixel data, and stored in frame buffer 224(0) as compressed pixel data. In such embodiments, SRC 220 may be configured to decode the compressed pixel data before generating the video signals used to drive LCD device 216. In yet other embodiments, GPU 240 may compress the frame of pixel data prior to encoding the compressed pixel data in the digital video signals transmitted to display device 110. For example, GPU 240 may be configured to encode the pixel data using an MPEG-2 format. In such embodiments, SRC 220 may store the compressed pixel data in local frame buffer 224(0) in the compressed format and decode the compressed pixel data before generating the video signals used to drive LCD device 216.

Display device 110 may be capable of displaying 3D video data, such as stereoscopic video data. Stereoscopic video data includes a left view and a right view of uncompressed pixel data for each frame of 3D video. Each view corresponds to a different camera position of the same scene captured approximately simultaneously. Some display devices are capable of displaying three or more views simultaneously, such as in some types of auto-stereoscopic displays.

In one embodiment, display device 110 may include a self-refresh capability in connection with stereoscopic video data. Each frame of stereoscopic video data includes two uncompressed frames of pixel data for display on LCD device 216. Each of the uncompressed frames of pixel data may be comprised of pixel data at the full resolution and color depth of LCD device 216. In such embodiments, local frame buffer 224(0) may be sized to hold one frame of stereoscopic video data. For example, to store uncompressed stereoscopic video data at WUXGA resolution and 24 bpp color depth, the size of local frame buffer 224(0) should be at least 13500 kB of addressable memory (2*1920*1200*24 bpp). Alternatively, local frame buffers 224 may include two frame buffers 224(0) and 224(1), each sized to store a single view of uncompressed pixel data for display on LCD device 216.

In yet other embodiments, SRC 220 may be configured to compress the stereoscopic video data and store the compressed stereoscopic video data in local frame buffers 224. For example, SRC 220 may compress the stereoscopic video data using Multiview Video Coding (MVC) as specified in the H.264/MPEG-4 AVC video compression standard. Alternatively, GPU 240 may compress the stereoscopic video data prior to encoding the compressed video data in the digital video signals for transmission to display device 110.

In one embodiment, display device 110 may include a dithering capability. Dithering allows display device 110 to display more perceived colors than the hardware of LCD device 216 is capable of displaying. Temporal dithering alternates the color of a pixel rapidly between two approximate colors in the available color palette of LCD device 216 such that the pixel is perceived as a different color not included in the available color palette of LCD device 216. For example, by alternating a pixel rapidly between white and black, a viewer may perceive the color gray. In a normal operating state, GPU 240 may be configured to alternate pixel data in successive frames of video such that the perceived colors in the image displayed by display device 110 are outside of the available color palette of LCD device 216. In a self-refresh mode, display device 110 may be configured to cache two successive frames of pixel data in local frame buffers 224. Then, SRC 220 may be configured to scan out the two frames of pixel data from local frame buffers 224 in an alternating fashion to generate the video signals for display on LCD device 216.

FIG. 2B illustrates a communications path 280 that implements an embedded DisplayPort interface, according to one embodiment of the present invention. Embedded DisplayPort (eDP) is a standard digital video interface for internal display devices, such as an internal LCD device in a laptop computer. Communications path 280 includes a main link (eDP) that includes 1, 2 or 4 differential pairs (lanes) for high bandwidth data transmission. The eDP interface also includes a hot-plug detect signal (HPD) as well as a single differential pair auxiliary channel (Aux). The main link is a unidirectional communication channel from GPU 240 to display device 110. In one embodiment, GPU 240 may be configured to transmit video signals generated from pixel data stored in frame buffers 244 over a single lane of the eDP main link. In alternative embodiments, GPU 240 may be configured to transmit the video signals over 2 or 4 lanes of the eDP main link.

The hot-plug detect signal, HPD, may be a signal connected from the display device 110 to GPU 240 for detecting a hot-plug event or for communicating an interrupt request from display device 110 to GPU 240. To indicate a hot-plug event, display device drives HPD high to indicate that a display device has been connected to communications path 280. After display device is connected to communications path 280, display device 110 may signal an interrupt request by quickly pulsing the HPD signal low for between 0.5 and 1 millisecond.

The auxiliary channel, Aux, is a low bandwidth, bidirectional half-duplex data communication channel used for transmitting command and control signals from GPU 240 to display device 110 as well as from display device 110 to GPU 240. In one embodiment, messages indicating that display device 110 should enter or exit a panel self-refresh mode may be communicated over the auxiliary channel. On the auxiliary channel, GPU 240 is a master device and display device 110 is a slave device. In such a configuration, data or messages may be sent from display device 110 to GPU 240 using the following technique. First, display device 110 indicates to GPU 240 that display device 110 would like to send traffic over the auxiliary channel by initiating an interrupt request over the hot-plug detect signal, HPD. When GPU 240 detects an interrupt request, GPU 240 sends a transaction request message to display device 110. Once display device 110 receives the transaction request message, display device 110 then responds with an acknowledgement message. Once GPU 240 receives the acknowledgement message, GPU 240 may read one or more register values in display device 110 to retrieve the data or messages over the auxiliary channel.

It will be appreciated by those of skill in the art that communications path 280 may implement a different video interface for transmitting video signals between GPU 240 and display device 110. For example, communications path 280 may implement a high definition multimedia interface (HDMI) or a low voltage differential signal (LVDS) video interface such as open-LDI. The scope of the invention is not limited to an Embedded DisplayPort video interface.

FIG. 2C is a conceptual diagram of digital video signals 250 generated by a GPU 240 for transmission over communications path 280, according to one embodiment of the present invention. As shown, digital video signals 250 is formatted for transmission over four lanes (251, 252, 253 and 254) of the main link of an eDP video interface. The main link of the eDP video interface may operate at one of three link symbol clock rates, as specified by the eDP specification (162 MHz, 270 MHz or 540 MHz). In one embodiment, GPU 240 sets the link symbol clock rate based on a link training operation that is performed to configure the main link when a display device 110 is connected to communications path 280. For each link symbol clock cycle 255, a 10-bit symbol, which encodes one byte of data or control information using 8b/10b encoding, is transmitted on each active lane of the eDP interface.

The format of digital video signals 250 enables secondary data packets to be inserted directly into the digital video signals 250 transmitted to display device 110. In one embodiment, the secondary data packets may include messages sent from GPU 240 to display device 110 that request display device 110 to enter or exit a panel self-refresh mode. Such secondary data packets enable one or more aspects of the invention to be realized over the existing physical layer of the eDP interface. It will be appreciated that this form of in-line signaling may be implemented in other packet based video interfaces and is not limited to embodiments implementing an eDP interface.

Secondary data packets may be inserted into digital video signals 250 during the vertical or horizontal blanking periods of the video frame represented by digital video signals 250. As shown in FIG. 2C, digital video signals 250 are packed one horizontal line of pixel data at a time. For each horizontal line of pixel data, the digital video signals 250 include a blanking start (BS) framing symbol during a first link clock cycle 255(00) and a corresponding blanking end (BE) framing symbol during a subsequent link clock cycle 255(05). The portion of digital video signals 250 between the BS symbol at link symbol clock cycle 255(00) and the BE symbol at link symbol clock cycle 255(5) corresponds to the horizontal blanking period.

Control symbols and secondary data packets may be inserted into digital video signals 250 during the horizontal blanking period. For example, a VB-ID symbol is inserted in the first link symbol clock cycle 255(01) after the BS symbol. The VB-ID symbol provides display device 110 with information such as whether the main video stream is in the vertical blanking period or the vertical display period, whether the main video stream is interlaced or progressive scan, and whether the main video stream is in the even field or odd field for interlaced video. Immediately following the VB-ID symbol, a video time stamp (Mvid7:0) and an audio time stamp (Maud7:0) are inserted at link symbol clock cycles 255(02) and 255(03), respectively. Dummy symbols may be inserted during the remainder of the link symbol clock cycles 255(04) during the horizontal blanking period. Dummy symbols may be a special reserved symbol indicating that the data in that lane during that link symbol clock cycle is dummy data. Link symbol clock cycles 255(04) may have a duration of a number of link symbol clock cycles such that the frame rate of digital video signals 250 over communications path 280 is equal to the refresh rate of display device 110.

A secondary data packet may be inserted into digital video signals 250 by replacing a plurality of dummy symbols during link symbol clock cycles 255(04) with the secondary data packet. A secondary data packet is framed by the special secondary start (SS) and secondary end (SE) framing symbols. Secondary data packets may include an audio data packet, link configuration information, or a message requesting display device 110 to enter or exit a panel self-refresh mode.

The BE framing symbol is inserted in digital video signals 250 to indicate the start of active pixel data for a horizontal line of the current video frame. As shown, pixel data P0 . . . PN has a RGB format with a per channel bit depth (bpc) of 8-bits. Pixel data P0 associated with the first pixel of the horizontal line of video is packed into the first lane 251 at link symbol clock cycles 255(06) through 255(08) immediately following the BE symbol. A first portion of pixel data P0 associated with the red color channel is inserted into the first lane 251 at link symbol clock cycle 255(06), a second portion of pixel data PO associated with the green color channel is inserted into the first lane 251 at link symbol clock cycle 255(07), and a third portion of pixel data P0 associated with the blue color channel is inserted into the first lane 251 at link symbol clock cycle 255(08). Pixel data P1 associated with the second pixel of the horizontal line of video is packed into the second lane 252 at link symbol clock cycles 255(06) through 255(08), pixel data P2 associated with the third pixel of the horizontal line of video is packed into the third lane 253 at link symbol clock cycles 255(06) through 255(08), and pixel data P3 associated with the fourth pixel of the horizontal line of video is packed into the fourth lane 254 at link symbol clock cycles 255(06) through 255(08). Subsequent pixel data of the horizontal line of video are inserted into the lanes 251-254 in a similar fashion to pixel data PO through P3. In the last link symbol clock cycle to include valid pixel data, any unfilled lanes may be padded with zeros. As shown, the third lane 253 and the fourth lane 254 are padded with zeros at link symbol clock cycle 255(13).

The sequence of data described above repeats for each horizontal line of pixel data in the frame of video, starting with the top most horizontal line of pixel data. A frame of video may include a number of horizontal lines at the top of the frame that do not include active pixel data for display on display device 110. These horizontal lines comprise the vertical blanking period and may be indicated in digital video signals 250 by setting a bit in the VB-ID control symbol.

FIG. 2D is a conceptual diagram of a secondary data packet 260 inserted in the horizontal blanking period of the digital video signals 250 of FIG. 2C, according to one embodiment of the present invention. A secondary data packet 260 may be inserted into digital video signals 250 by replacing a portion of the plurality of dummy symbols in digital video signals 250. For example, FIG. 2D shows a plurality of dummy symbols at link symbol clock cycles 265(00) and 265(04). GPU 240 may insert a secondary start (SS) framing symbol at link symbol clock cycle 265(01) to indicate the start of a secondary data packet 260. The data associated with the secondary data packet 260 is inserted at link symbol clock cycles 265(02). Each byte of the data (SB0 . . . SBN) associated with the secondary data packet 260 is inserted in one of the lanes 251-254 of digital video signals 250. Any slots not filled with data may be padded with zeros. GPU 240 then inserts a secondary end (SE) framing symbol at link symbol clock cycle 265(03).

In one embodiment, the secondary data packet 260 may include a header and data indicating that the display device 110 should enter or exit a self-refresh mode. For example, the secondary data packet 260 may include a reserved header code that indicates that the packet is a panel self-refresh packet. The secondary data packet may also include data that indicates whether display device 110 should enter or exit a panel self-refresh mode.

As described above, GPU 240 may send messages to display device 110 via an in-band signaling method, using the existing communications channel for transmitting digital video signals 250 to display device 110. In alternative embodiments, GPU 240 may send messages to display device 110 via a side-band method, such as by using the auxiliary communications channel in communications path 280. In yet other embodiments, a dedicated communications path, such as an additional cable, may be included to provide signaling to display device 110 to enter or exit the panel self-refresh mode.

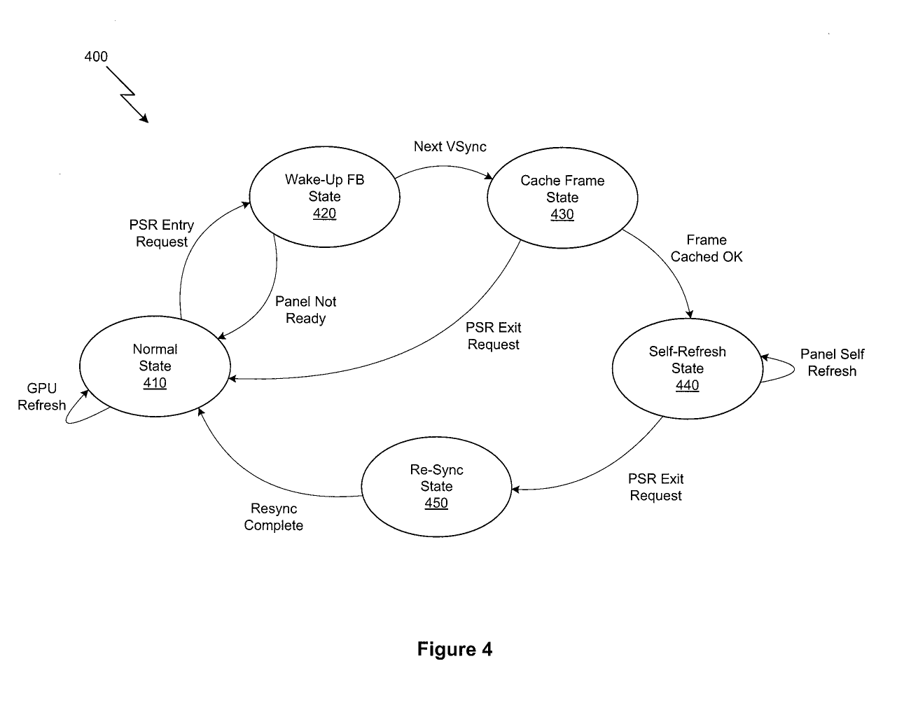

FIG. 3 illustrates communication signals between parallel processing subsystem 112 and various components of computer system 100, according to one embodiment of the present invention. As shown, computer system 100 includes an embedded controller (EC) 310, an SPI flash device 320, a system basic input/output system (SBIOS) 330, and a driver 340. EC 310 may be an embedded controller that implements an advanced configuration and power interface (ACPI) that allows an operating system executing on CPU 102 to configure and control the power management of various components of computer system 100. In one embodiment, EC 310 allows the operating system executing on CPU 102 to communicate with GPU 240 via driver 340 even when the PCIe bus is down. For example, if GPU 240 and the PCIe bus are shut down in a power saving mode, the operating system executing on CPU 102 may instruct EC 310 to wake-up GPU 240 by sending a notify ACPI event to EC 310 via driver 340.

Computer system 100 may also include multiple display devices 110 such as an internal display panel 110(0) and one or more external display panels 110(1) . . . 110(N). Each of the one or more display devices 110 may be connected to GPU 240 via communication paths 280(0) . . . 280(N). In one embodiment, each of the HPD signals included in communication paths 280 are also connected to EC 310. When one or more display devices 110 are operating in a panel self-refresh mode, EC 310 may be responsible for monitoring HPD and waking-up GPU 240 if EC 310 detects a hot-plug event or an interrupt request from one of the display devices 110.

In one embodiment, a GEN_LCK signal is included between internal display device 110(0) and GPU 240. GEN_LCK passes a synchronization signal from the display device 110(0) to GPU 240. The GEN_LCK signal may be included in some re-synchronization routines implemented by display device 110(0), discussed below in conjunction with FIGS. 9A-9C, and 10-13. For example, GPU 240 may synchronize video signals generated from pixel data in frame buffers 244 with the GEN_LCK signal. GEN_LCK may indicate the start of the active frame such as by passing the vertical sync signal used by TCON 210 to drive LCD device 216 to GPU 240.

EC 310 transmits the GPU_PWR and FB_PWR signals to voltage regulators that provide a supply voltage to the GPU 240 and frame buffers 244, respectively. EC 310 also transmits the WARMBOOT, SELF_REF and RESET signals to GPU 240 and receives a GPUEVENT signal from GPU 240. Finally, EC 310 may communicate with GPU 240 via an I2C or SMBus data bus. The functionality of these signals is described below.

The GPU_PWR signal controls the voltage regulator that provides GPU 240 with a supply voltage. When display device 110 enters a self-refresh mode, an operating system executing on CPU 102 may instruct EC 310 to kill power to GPU 240 by making a call to driver 340. Driver 340 will then drive the GPU_PWR signal low to kill power to GPU 240 to reduce the overall power consumption of computer system 100. Similarly, the FB_PWR signal controls the voltage regulator that provides frame buffers 244 with a supply voltage. When display device 110 enters the self-refresh mode, computer system 100 may also kill power to frame buffers 244 in order to further reduce overall power consumption of computer system 100. The FB_PWR signal is controlled in a similar manner to the GPU_PWR signal. The RESET signal may be asserted during wake-up of the GPU 240 to hold GPU 240 in a reset state while the voltage regulators that provide power to GPU 240 and frame buffers 244 are allowed to stabilize.

The WARMBOOT signal is asserted by EC 310 to indicate that GPU 240 should restore an operating state from SPI flash device 320 instead of performing a full, cold-boot sequence. In one embodiment, when display device 110 enters a panel self-refresh mode, GPU 240 may be configured to save a current state in SPI flash device 320 before GPU 240 is powered down. GPU 240 may then restore an operating state by loading the saved state information from SPI flash device 320 upon waking-up. Loading the saved state information reduces the time required to wake-up GPU 240 relative to performing a full, cold-boot sequence. Reducing the time required to wake-up GPU 240 is advantageous during high frequency entry and exit into a panel self-refresh mode.

The SELF_REF signal is asserted by EC 310 when display device 110 is operating in a panel self-refresh mode. The SELF_REF signal indicates to GPU 240 that display device 110 is currently operating in a panel self-refresh mode and that communications path 280 should be isolated to prevent transients from disrupting the data stored in local frame buffers 224. In one embodiment, GPU 240 may connect communications path 280 to ground through weak, pull-down resistors when the SELF_REF signal is asserted.

The GPUEVENT signal allows the GPU 240 to indicate to CPU 102 that an event has occurred, even when the PCIe bus is off. GPU 240 may assert the GPUEVENT to alert system EC 310 to configure the I2C/SMBUS to enable communication between the GPU 240 and the system EC 310. The I2C/SMBUS is a bidirectional communication bus configured as an I2C, SMBUS, or other bidirectional communication bus to enable GPU 240 and system EC 310 to communicate. In one embodiment, the PCIe bus may be shut down when display device 110 is operating in a panel self-refresh mode. The operating system may notify GPU 240 of events, such as cursor updates or a screen refresh, through system EC 310 even when the PCIe bus is shut down.

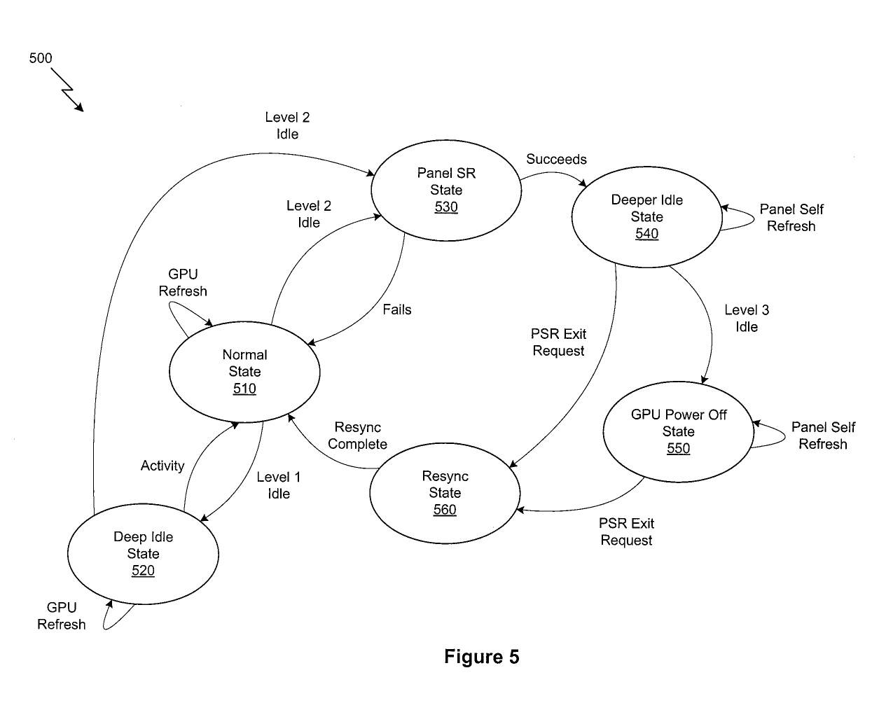

FIG. 4 is a state diagram 400 for a display device 110 having a self-refreshing capability, according to one embodiment of the present invention. As shown, display device 110 begins in a normal state 410. In the normal state 410, display device receives video signals from GPU 240. TCON 210 drives the LCD device 216 using the video signals received from GPU 240. In the normal operating state, display device 110 monitors communications path 280 to determine if GPU 240 has issued a panel self-refresh entry request. If display device 110 receives the panel self-refresh entry request, then display device 110 transitions to a wake-up frame buffer state 420.

In the wake-up frame buffer state 420, display device 110 wakes-up the local frame buffers 224. If display device 110 cannot initialize the local frame buffers 224, then display device 110 may send an interrupt request to GPU 240 indicating that the display device 110 has failed to enter the panel self-refresh mode and display device 110 returns to normal state 410. In one embodiment, display device 110 may be required to initialize the local frame buffers 224 before the next frame of video is received over communications path 280 (i.e., before the next rising edge of the VSync signal generated by GPU 240). Once display device 110 has completed initializing local frame buffers 224, display device 110 transitions to a cache frame state 430.

In the cache frame state 430, display device 110 waits for the next falling edge of the VSync signal generated by GPU 240 to begin caching one or more frames of video in local frame buffers 224. In one embodiment, GPU 240 may indicate how many consecutive frames of video to store in local frame buffers 224 by writing a value to a control register in display device 110. After display device has stored the one or more frames of video in local frame buffers 224, display device 110 transitions to a self-refresh state 440.

In the self-refresh state 440, the display device 110 enters a panel self-refresh mode where ICON 210 drives the LCD device 216 with video signals generated by SRC 220 based on pixel data stored in local frame buffers 224. Display device 110 stops driving the LCD device 216 based on the video signals generated by GPU 240. Consequently, GPU 240 and communications path 280 may be placed in a power saving mode to reduce the overall power consumption of computer system 100. While in the self-refresh state 440, display device 110 may monitor communications path 280 to detect a request from GPU 240 to exit the panel self-refresh mode. If display device 110 receives a panel self-refresh exit request, then display device 110 transitions to a re-sync state 450.

In the re-sync state 450, display device 110 attempts to re-synchronize the video signals generated by GPU 240 with the video signals generated by SRC 220. Various techniques for re-synchronizing the video signals are described below in conjunction with FIGS. 9A-9C and 10-13. When display device 110 has completed re-synchronizing the video signals, then display device 110 transitions back to a normal state 410.

In one embodiment, display device 110 may be configured to quickly exit wake-up frame buffer state 420 and cache frame state 430 if display device 110 receives an exit panel self-refresh exit request. In both of these states, display device 110 is still synchronized with the video signals generated by GPU 240. Thus, display device 110 may transition quickly back to normal state 410 without entering re-sync state 450. Once display device 110 is in self-refresh state 440, display device 110 is required to enter re-sync state 450 before returning to normal state 410.

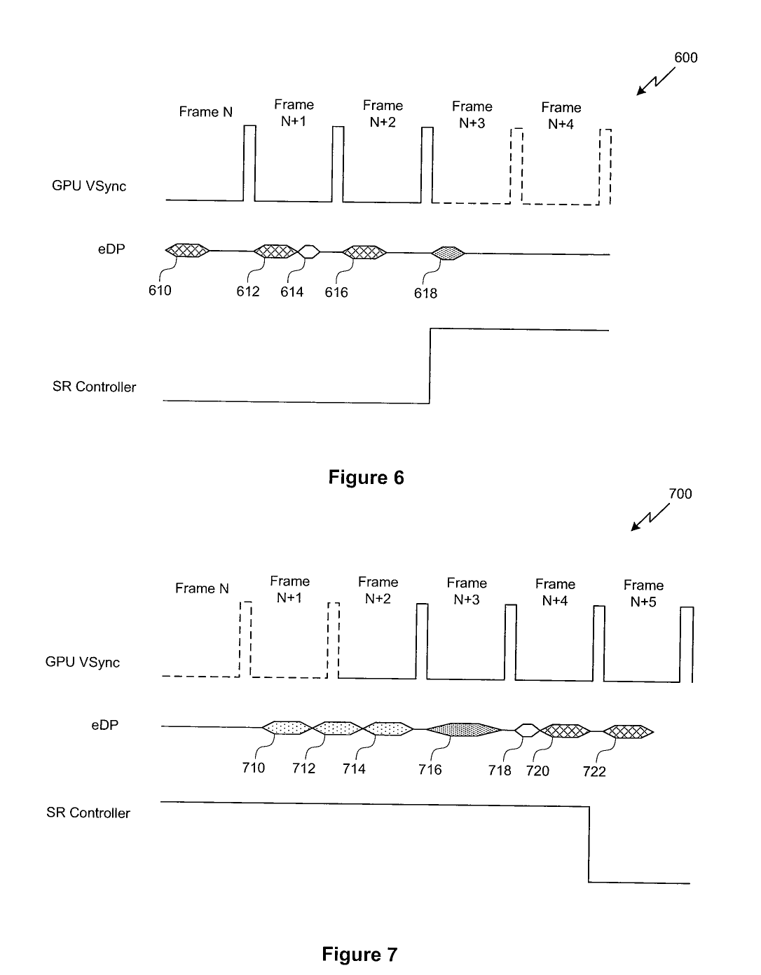

FIG. 5 is a state diagram 500 for a GPU 240 configured to control the transition of a display device 110 into and out of a panel self-refresh mode, according to one embodiment of the present invention. After initial configuration from a cold-boot sequence, GPU 240 enters a normal state 510. In the normal state, GPU 240 generates video signals for transmission to display device 110 based on pixel data stored in frame buffers 244. In one embodiment, GPU 240 monitors pixel data in frame buffers 244 to detect one or more progressive levels of idleness in the pixel data. For example, GPU 240 may compare the current frame of pixel data in frame buffers 244 with the previous frame of pixel data in frame buffers 244 to detect any graphical activity in the pixel data. Graphical activity may be detected if the pixel data is different between the two frames. GPU 240 may count a consecutive number of frames that remain static and compare the number to one or more threshold values to detect one or more levels of idleness. In another embodiment, GPU 240 may also determine whether any pending operations are scheduled in the GPU 240 that may result in updated pixel data being written to frame buffers 244. If such pending operations are scheduled, then GPU 240 will wait to compare the number to one or more threshold levels until there are no currently pending operations scheduled in the GPU 240. In alternative embodiments, GPU 240 may detect progressive levels of idleness based on a factor other than the comparison of consecutive frames of pixel data in frame buffers 244. If GPU 240 fails to detect any graphical activity in the pixel data stored in frame buffers 244, then GPU 240 may increment a counter that indicates the number of consecutive frames of video without any graphical activity. If the counter reaches a first threshold value, then GPU 240 transitions to a deep-idle state 520.

In the deep-idle state 520, GPU 240 still generates video signals for display on display device 110. However, GPU 240 operates in a power saving mode, such as by clock-gating or power-gating certain processing portions of GPU 240 while keeping the portions of GPU 240 responsible for generating the video signals active. Additionally, GPU 240 may send a message to display device 110 requesting display device 110 to drive LCD device 216 at a lower refresh rate. For example, GPU 240 may request display device 110 to reduce the refresh rate from 75 Hz to 30 Hz, and GPU 240 may generate and transmit video signals based on the lower refresh rate. While operating in deep-idle state 520, GPU 240 may continue to monitor pixel data in frame buffers 244 for graphical activity. If GPU 240 detects graphical activity, GPU 240 transitions back to normal state 510. Returning to deep-idle state 520, GPU 240 may continue to increment the counter to determine the number of consecutive frames of video without any graphical activity. If the counter reaches a second threshold value, that is greater than the first threshold value, then GPU 240 transitions to a panel self-refresh state 530.

In some embodiments, the state diagram 500 does not include the deep-idle state 520. In such embodiments, GPU 240 may transition directly from the normal state 510 to the panel self-refresh state 530 when the counter reaches the second threshold value. In yet other embodiments, EC 310, graphics driver 103, or some other dedicated monitoring unit, may perform the monitoring of the pixel data in frame buffers 244 and send a message to GPU 240 over the I2C/SMBUS indicating that one of the progressive levels of idleness has been detected.

In the panel self-refresh state 530, GPU 240 transmits the one or more video frames for display during the panel self-refresh mode to display device 110. GPU 240 may monitor communications path 280 to detect a failure by display device 110 in entering self-refresh mode. In one embodiment, GPU 240 monitors the HPD signal to detect an interrupt request issued by display device 110. If GPU 240 detects an interrupt request from display device 110, then GPU 240 may configure the Auxiliary channel of communications path 280 to receive communications from display device 110. If display device 110 indicates that entry into self-refresh mode did not succeed, then GPU 240 may transition back to normal state 510. Otherwise, GPU 240 transitions to a deeper-idle state 540.

In the deeper-idle state 540, GPU 240 may be placed in a sleep state and the transmitter side of communications path 280 may be shut down. Portions of GPU 240 may be clock-gated or power-gated in order to reduce the overall power consumption of computer system 100. Display device 110 is responsible for refreshing the image displayed by display device 110. In one embodiment, GPU 240 may continue to monitor the pixel data in frame buffers 244 to detect a third level of idleness. For example, GPU 240 may continue to increment a counter for each frame of video where GPU 240 fails to update the pixel data in frame buffers 244. If GPU 240 detects graphical activity, such as by receiving a signal from EC 310 over the I2C/SMBUS or from graphics driver 103 over the PCIe bus, then GPU 240 transitions to the re-sync state 560. In contrast, if GPU 240 detects a third level of idleness in the pixel data, then GPU 240 transitions to a GPU power-off state 550.

In the GPU power-off state 550, EC 310 shuts down GPU 240 by turning off the voltage regulator supplying power to GPU 240. EC 310 may drive the GPU_PWR signal low to shut down the voltage regulator supplying GPU 240. In one embodiment, GPU 240 may save the current operating context in SPI flash device 320 in order to perform a warm-boot, fast resume sequence on wake-up. In GPU power off state 550, a voltage regulator supplying power to graphics memory 242 may also be turned off. EC 310 may drive the FB_PWR signal low to shut down the voltage regulator supplying graphics memory 242. It will be appreciated by one of ordinary skill in the art that in yet other embodiments, other related subsystems (not shown) may also be placed in a power saving state, such as by turning off a voltage regulator that supplies power to the subsystems.

When GPU 240 is in either the deeper-idle state 540 or the GPU power-off state 550, GPU 240 may be instructed to wake-up by EC 310 to update the image being displayed on display device 110. For example, a user of computer system 100 may begin typing into an application that requires GPU 240 to update the image displayed on the display device. In one embodiment, driver 340 may instruct EC 310 to assert the GPU_PWR and FB_PWR signals to turn on the voltage regulators supplying GPU 240 and frame buffers 244. When GPU 240 is turned on, GPU 240 will perform a boot sequence based on the status of the WARMBOOT signal and the RESET signal. If EC 310 asserts the WARM_BOOT signal, then GPU 240 may load a stored context from the SPI flash device 320. Otherwise GPU 240 may perform a cold-boot sequence. GPU 240 may also configure the transmitter side of communications path 280 based on information stored in SPI flash device 320. After GPU 240 has performed the boot sequence, GPU 240 may send a panel self-refresh exit request to display device 110. GPU 240 then transitions to a re-sync state 560.

In the re-sync state 560, GPU 240 begins generating video signals based on pixel data stored in frame buffers 244. The video signals are transmitted to display device 110 over communications path 280 and display device 110 attempts to re-synchronize the video signals generated by GPU 240 with the video signals generated by SRC 220. After re-synchronizing the video signals is complete, GPU 240 transitions back to the normal state 510.

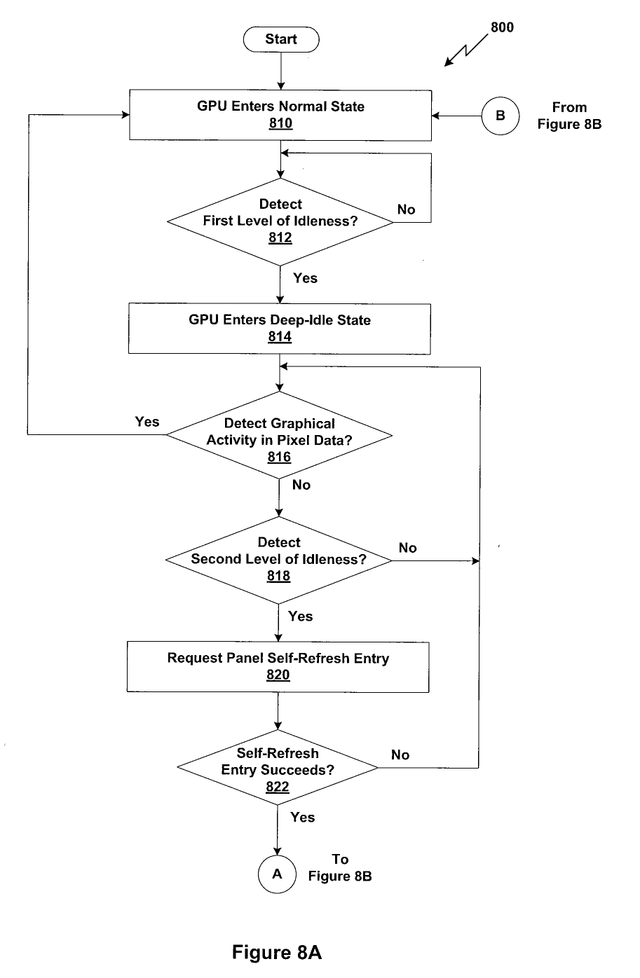

FIG. 6 illustrates a timing diagram 600 for sending a panel self-refresh entry request to a display device 110, according to one embodiment of the present invention. In one embodiment, communications path 280 implements an eDP interface. As shown, the panel self-refresh entry request is sent using an in-band signaling technique over the existing eDP main link. GPU 240 transmits active frames 610, 612 and 616 to display device 110 over the eDP main link of communications path 280. Active frame 610 includes the pixel data for frame N and active frame 612 includes pixel data for frame N+1. In one embodiment, GPU 240 sends the panel self-refresh mode entry request using an infoframe packet 614. The infoframe packet 614 may include a header configured to identify the infoframe packet 614 as a panel self-refresh packet. The infoframe packet 614 may also include data configured to indicate to display device 110 that the infoframe packet 614 is a panel self-refresh entry request. GPU 240 may request display device 110 to enter a panel self-refresh mode by setting a bit in the infoframe packet 614.

When display device 110 receives infoframe packet 614, display device 110 attempts to enter the panel self-refresh mode. At frame N+2, display device 110 stores the pixel data in active video frame 616 in local frame buffers 224. At frame N+3, display device 110 enters the panel self-refresh mode and SRC 220 generates the video signals used to drive LCD device 216 from the pixel data stored in local frame buffers 224. In one embodiment, GPU 240 may be configured to send an additional frame 618 at frame N+3 before shutting down communications path 280. The additional frame 618 received after the display device 110 has entered panel self-refresh mode may be ignored and is not displayed on LCD device 216. Transmitting the additional frame 618 may ensure that GPU 240 receives an interrupt request from display device 110 in the event that display device 110 fails to enter the panel self-refresh mode by not allowing GPU 240 to shut down communications path 280 before display device 110 asserts the interrupt request. At frame N+4, display device 110 operates in the panel self-refresh mode continuously generating video signals based on the pixel data included in active frame 616. In alternative embodiments, two or more additional frames, such as frame 618, may be transmitted to display device 110 before shutting down communications path 280. Each of the additional frames may be ignored by display device 110 and none of the additional frames is displayed on LCD device 216.

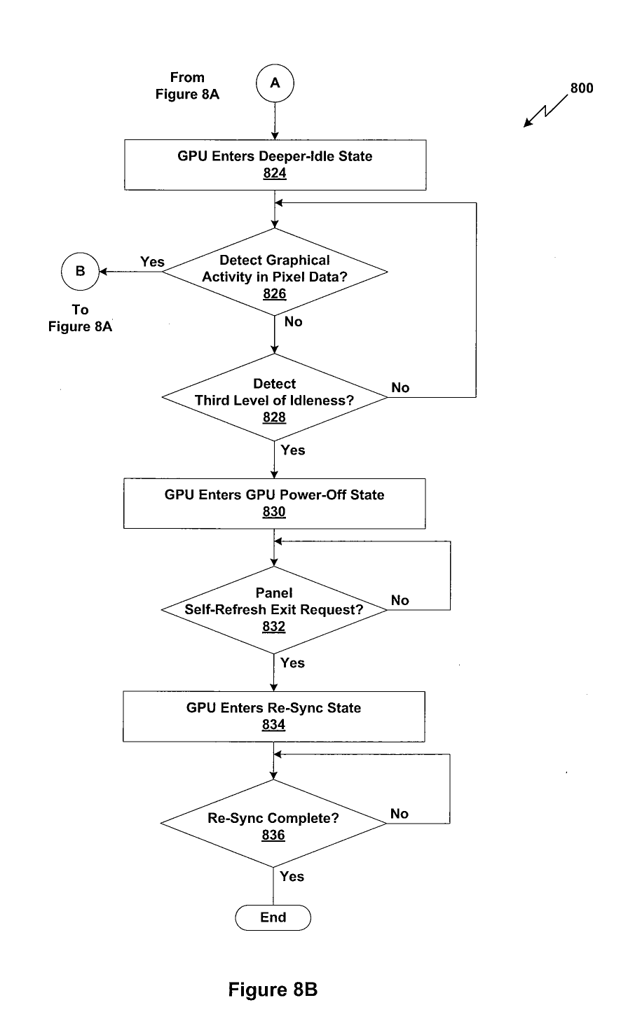

FIG. 7 illustrates a timing diagram 700 for sending a panel self-refresh exit request to a display device 110, according to one embodiment of the present invention. The technique for sending the panel self-refresh exit request is similar to the technique for sending the panel self-refresh entry request, described above in conjunction with FIG. 6. At frame N, display device 110 is currently operating in a panel self-refresh mode. During frame N+1, GPU 240 wakes-up begins sending data over communications path 280. In one embodiment, GPU 240 sends training pattern 1 (TP1) 710 followed by training pattern 2 (TP2) 712 as well as idle pattern 714 over the eDP interface of communications path 280. TP1 and TP2 are training patterns for performing a fast link training process to configure the main link of the eDP interface. At frame N+3, GPU 240 may be configured to send one or more frames 716 to display device 110. All frames 716 received by display device 110 before a panel self-refresh exit request are ignored by display device 110 and are not displayed on LCD device 216. At frame N+4, GPU 240 sends the panel self-refresh mode exit request using an infoframe packet 718. The infoframe packet 718 may include a header configured to identify the infoframe packet 718 as a panel self-refresh packet. The infoframe packet 718 may also include data configured to indicate to display device 110 that the infoframe packet 718 is a panel self-refresh exit request. GPU 240 may request display device 110 to exit a panel self-refresh mode by setting a bit in the infoframe packet 718. GPU 240 may then send active video frame 720 to display device 110, which transitions back to driving the LCD device 216 based on the video signals generated by GPU 240 and exits panel self-refresh mode. At frame N+5, GPU 240 transmits active frame 722 for display on display device 110.

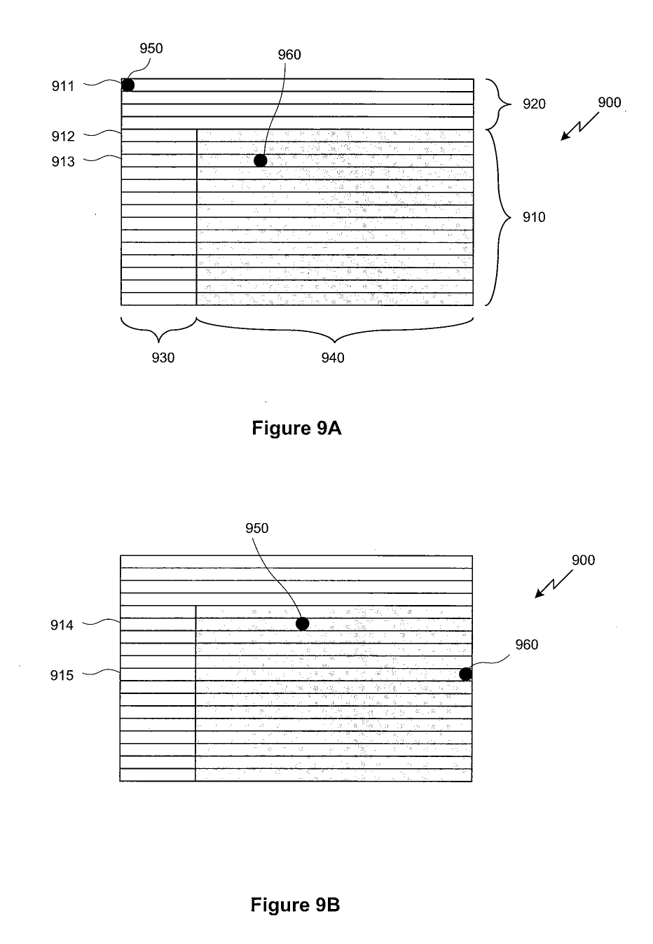

FIGS. 8A-8B set forth a flowchart of a method 800 for controlling a self-refreshing display device 110, according to one embodiment of the present invention. Although the method steps are described in conjunction with the systems of FIGS. 1, 2A-2D, and 3-7, persons skilled in the art will understand that any system configured to perform the method steps, in any order, is within the scope of the invention.

The method 800 begins at step 810, where GPU 240 enters a normal state 510. In the normal state 510, GPU 240 may generate video signals for display on display device 110 based on pixel data in frame buffers 244. GPU 240 may also process graphics primitives received from CPU 102 to generate the pixel data in frame buffers 244. At step 812, GPU 240 monitors the pixel data in frame buffers 244 to detect a first level of idleness. In one embodiment, GPU 240 may calculate the number of consecutive frames of video where the pixel data remains static. If the number of consecutive frames of static video is greater than or equal to a first threshold value, then GPU 240 proceeds to step 814 where GPU 240 enters a deep-idle state 520.

In the deep-idle state 520, GPU 240 is configured to reduce power consumption by clock gating or power gating portions of GPU 240 while continuing to generate video signals based on the pixel data stored in frame buffers 244. At step 816, GPU 240 monitors the pixel data in frame buffers 244 to detect any graphical activity. In one embodiment, graphical activity may be any change in the pixel data in frame buffers 244 compared to the pixel data used to generate the previous video frame. If GPU 240 detects graphical activity, then GPU 240 proceeds to step 810 and transitions back to the normal state 510. However, if GPU 240 does not detect graphical activity, then GPU 240 proceeds to step 818 where GPU 240 monitors the pixel data in frame buffers 244 to detect a second level of idleness. In one embodiment, GPU 240 may calculate the number of consecutive frames of video where the pixel data remains static. If the number of consecutive frames of static video is less than a second threshold number of frames, then method 800 returns to step 816 where GPU 240 continues to operate in the deep-idle state 520. If the number of consecutive frames of static video is greater than or equal to the second threshold number of frames, then GPU 240 determines that the pixel data has reached a second level of idleness, and GPU 240 proceeds to step 820 where GPU 240 transitions to a panel self-refresh state 530.

At step 820, GPU 240 issues a panel self-refresh entry request to display device 110. At step 822, GPU 240 determines whether display device 110 successfully entered a panel self-refresh state. In one embodiment, display device 110 is configured to transmit an interrupt request over the HPD signal of communications path 280 if display device 110 fails to enter a self-refresh mode. The interrupt request must be asserted before the rising edge of the first vertical synchronization (VSync) pulse after the cached video frame is transmitted to display device 110. If display device 110 successfully entered the panel self-refresh mode, then GPU 240 proceeds to step 824 where GPU 240 transitions to a deeper-idle state 540.

At step 824, GPU 240 enters a reduced power state, such as by clock gating or power gating portions of GPU 240 and turning off the transmitter side of communications path 280. At step 826, GPU 240 determines if there is any graphical activity in the pixel data in frame buffers 244. If GPU 240 detects graphical activity, then GPU 240 proceeds to step 810 and transitions to the normal state 510. At step 828, GPU 240 monitors the pixel data in frame buffers 244 to detect a third level of idleness. In one embodiment, GPU 240 may continue to increment a counter for each frame of video where GPU 240 fails to update the pixel data in frame buffers 244. If the number of frames of video is greater than or equal to a third threshold value, then GPU 240 proceeds to step 830 where GPU 240 transitions to a GPU power-off state 550.

At step 830, GPU 240 and the PCIe bus may be shut down. In one embodiment, GPU 240 may save a current operating context in the SPI flash device 320, and the voltage regulators that supply power to GPU 240 and frame buffers 244 may be turned off. At step 832, GPU 240 is woken up by EC 310 to transmit a panel self-refresh exit request to display device 110. In one embodiment, the operating system executing on computer system 100 notifies EC 310 to wake-up GPU 240 and to send a panel self-refresh exit request to display device 110. At step 834, GPU 240 enters a re-sync state 560. In the re-sync state 560, GPU 240 begins transmitting video signals to display device 110 and waits for display device 110 to re-synchronize the video signals generated by GPU 240 with the video signals generated by SRC 220.

At step 836, GPU 240 determines whether the re-synchronization process is complete. If GPU 240 determines that display device 110 has completed the re-synchronization process, then method 800 terminates.

### Re-Synchronization Implementations

When display device 110 exits the panel self-refresh mode, display device 110 ensures that the pixel location associated with the video signals generated by GPU 240 is aligned with the pixel location associated with the video signals generated by SRC 220. Various implementations for re-synchronizing the video signals are described below in conjunction with FIGS. 9A-9C and 10-13.

FIGS. 9A-9C are conceptual diagrams of a video frame 900 that illustrate various re-synchronization processes implemented by a display device 110, according to one embodiment of the present invention. As shown in FIG. 9A, video frame 900 includes of a plurality of horizontal lines of pixel data. Video frame 900 includes an vertical display portion 910 and a vertical blanking portion 920. Each horizontal line of pixel data in the vertical display portion 910 includes a horizontal blanking portion 930 as well as an active pixel portion 940. The active pixel portion 940 of the video frame includes the pixel data to be displayed on display device 110. A first horizontal line of pixel data 911 corresponds to the first line of pixel data received during the vertical blanking portion 920. A second horizontal line of pixel data 912 corresponds to the first line of pixel data received during the vertical display portion 910.

Pixel locations 950 and 960 represent the current pixel locations associated with the video signals generated by the GPU 240 and the SRC 220, respectively, at the point in time when display device 110 receives a panel self-refresh exit request. As shown, pixel location 950 represents the first pixel location in video frame 900 as GPU 240 starts generating video signals from the pixel data in frame buffers 244. Pixel location 960 represents the current pixel location associated with the video signals generated by SRC 220 at this same point in time. Pixel location 960 is located on a third horizontal line of pixel data 913 located in the vertical display portion 910 of video frame 900.

In one embodiment, display device 110 may implement a re-synchronization process that forces the refresh of LCD device 216 to restart at the top left pixel location of LCD device 216 on the falling edge of the VSync signal associated with the video signals generated by GPU 240. As illustrated in FIG. 9A, immediately before the falling edge of the VSync signal associated with the video signals generated by GPU 240, LCD device 216 is currently updating pixel location 960 based on the video signals generated by SRC 220. At the falling edge of the VSync signal associated with the video signals generated by GPU 240, pixel location 950 is associated with the video signals generated by GPU 240. Consequently, in this implementation of the re-synchronization process, display device 110 forces the refresh of LCD device 216 to restart at the pixel location corresponding to pixel location 950.

In another embodiment, display device 110 may implement a re-synchronization process that synchronizes the video signals generated by GPU 240 to timing information passed from display device 110 to GPU 240. Communications path 280 may include a GEN_LCK signal to pass the VSync signal to GPU 240. GPU 240 delays generating video signals until the display device 110 finishes driving LCD device 216 for the current frame of pixel data. After the video signals generated by SRC 220 reach the next vertical blanking period, display device 110 transitions to driving the LCD device 216 with the digital video signals generated by GPU 240.

In yet another embodiments, display device 110 may implement a re-synchronization process that checks for alignment of the video signals during each blanking period (either vertical or horizontal depending on the implementation). The display device 110 may implement different techniques to ensure that the refresh rate of the video signals generated by SRC 220 are relatively slower than the refresh rate of the video signals generated by GPU 240. For example, display device 110 may set the refresh rate of the video signals generated by SRC 220 to a refresh rate equal to the slowest refresh rate capable of driving LCD device 216. Alternatively, GPU 240 and SRC 220 could be configured to scan-out the pixel data from frame buffers 244 or local frame buffers 224, respectively, at the same rate, however, SRC 220 may be configured to “stretch” the vertical blanking period or horizontal blanking period to effectively slow down the refresh rate of the video signals generated by SRC 220. It will be appreciated that any technically feasible method for ensuring that the refresh rates of the video signals generated by GPU 240 and SRC 220 are different may be implemented by display device 110 or GPU 240. Thus, in such embodiments, the video signals generated by SRC 220 correspond to a low refresh rate and the video signals generated by GPU 240 correspond to a relatively higher refresh rate. Consequently, as the video signals advance in time, pixel location 950 will “catch up” to pixel location 960. GPU 240 and SRC 220 generate the video signals until the pixel locations associated with the video signals are aligned.

After receiving the panel self-refresh exit request at a point in time corresponding to pixel locations as shown in FIG. 9A, display device 110 delays transition of control for driving LCD device 216 from SRC 220 to GPU 240 until a later point in time where pixel location 950 and pixel location 960 are relatively close together. In one embodiment, display device 110 waits until the digital video signal generated by SRC 220 reaches the end of the current horizontal line of pixel data. Display device 110 then determines a first pixel location associated with the video signals generated by GPU 240 and compares the first pixel location to a second pixel location associated with the digital video signals generated by SRC 220. If the difference between the first pixel location and the second pixel location is less than or equal to a trigger distance, such as the width of one horizontal line of pixel data, display device 110 delays the horizontal blanking period of the video signals generated by SRC 220 until the video signals generated by GPU 240 “catch up” and display device 110 transitions control for driving LCD device 216 from SRC 220 to GPU 240. If the difference between the first pixel location and the second pixel location is greater than the trigger distance, then display device 110 continues to drive LCD device 216 based on digital video signals generated by SRC 220 until the end of the next horizontal line of pixel data.

For example, as shown in FIG. 9B, the video signals generated by GPU 240 and SRC 220 have advanced to a point corresponding to pixel locations 950 and 960, respectively. Pixel location 950 is in a fourth horizontal line of pixel data 914 and pixel location 960 is in a fifth horizontal line of pixel data 915. As the video signals generated by SRC 220 reach the end of the fifth horizontal line of pixel data 914, display device 110 compares pixel location 950 to pixel location 960. As shown, pixel location 950 is more than the trigger distance of one horizontal line of pixel data from pixel location 960. Thus, display device 110 continues to drive LCD device 216 based on the video signals generated by SRC 220.

As shown in FIG. 9C, the video signals generated by GPU 240 and SRC 220 have advanced further in the video frame until the video signals generated by SRC 220 reach the end of a sixth horizontal line of pixel data 916. When display device 110 compares pixel location 950 to pixel location 960, pixel location 950 is less than the trigger distance from pixel location 960. Thus, display device 110 may delay the horizontal blanking period until the video signals generated by GPU 240 “catch up” to the video signals generated by SRC 220. At this point, pixel location 950 and pixel location 960 will be aligned, and display device 110 may transition control for driving LCD device 216 from SRC 220 to GPU 240.

In still yet another embodiment, display device 110 is configured to compare the pixel locations associated with video signals generated by GPU 240 and SRC 220 at a vertical boundary. In such embodiments, display device 110 may wait until the falling edge of the VSync signal associated with the video signals generated by SRC 220. Display device 110 then determines whether the video signals generated by GPU 240 are in the vertical blanking period. If the video signals generated by GPU 240 are in the vertical blanking period, then display device 110 may delay the vertical blanking period until the video signals generated by GPU 240 “catch up” to the video signals generated by SRC 220, and display device 110 may transition control for driving LCD device 216 from SRC 220 to GPU 240.

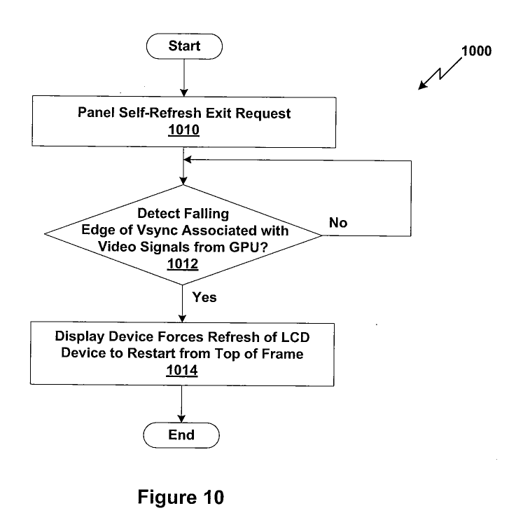

FIG. 10 sets forth a flowchart of a method 1000 for re-synchronizing the video signals generated by GPU 240 with the video signals generated by SRC 220, according to one embodiment of the present invention. Although the method steps are described in conjunction with the systems of FIGS. 1, 2A-2D, 3-7, and 9A-9C, persons skilled in the art will understand that any system configured to perform the method steps, in any order, is within the scope of the invention.

Method 1000 begins at step 1010 where display device 110 receives a panel self-refresh exit request. At step 1010, display device 110 is currently operating in a panel self-refresh mode where video signals generated by SRC 220 drive LCD device 216 based on pixel data in frame buffers 224. At step 1012, display device 110 detects a falling edge of the VSync signal associated with the video signals generated by GPU 240. When display device 110 detects the falling edge of the VSync signal, display device 110 proceeds to step 1014 where display device 110 forces the refreshing of LCD device 216 to restart at the pixel location associated with the video signals generated by GPU 240. Display device 110 transitions control for driving LCD device 216 from SRC 220 to GPU 240 and method 1000 terminates.

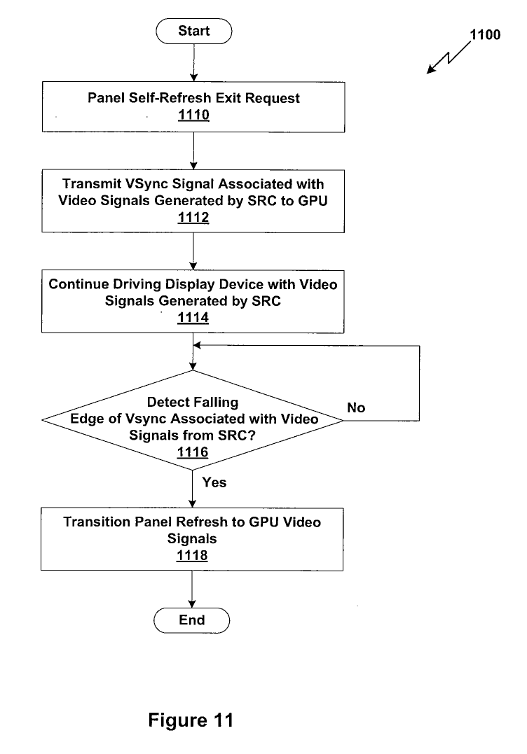

FIG. 11 sets forth a flowchart of a method 1100 for re-synchronizing the video signals generated by GPU 240 with the video signals generated by SRC 220, according to another embodiment of the present invention. Although the method steps are described in conjunction with the systems of FIGS. 1, 2A-2D, 3-7, and 9A-9C, persons skilled in the art will understand that any system configured to perform the method steps, in any order, is within the scope of the invention.

Method 1100 begins at step 1110 where display device 110 receives a panel self-refresh exit request. At step 1112, display device 110 transmits the VSync signal associated with the video signals generated by SRC 220 to GPU 240. Providing GPU 240 with the VSync signal enables GPU 240 to synchronize the video signals generated by GPU 240 with the video signals generated by SRC 220. At step 1114, display device 110 continues to drive LCD device 216 with the video signals generated by SRC 220. At step 1116, display device 110 monitors the VSync signal associated with the video signals generated by SRC 220 to detect a falling edge of the VSync signal. If display device 110 detects a falling edge of a VSync signal associated with the video signals generated by SRC 220, then display device 110 proceeds to step 1118, where display device 110 transitions control for driving LCD device 216 from SRC 220 to GPU 240 and method 1100 terminates.

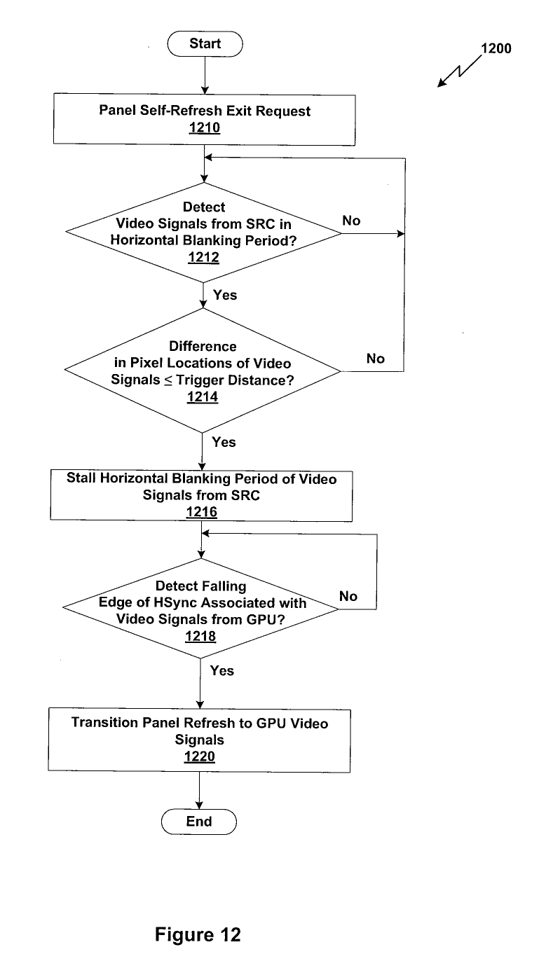

FIG. 12 sets forth a flowchart of a method 1200 for re-synchronizing the video signals generated by GPU 240 with the video signals generated by SRC 220, according to another embodiment of the present invention. Although the method steps are described in conjunction with the systems of FIGS. 1, 2A-2D, 3-7, and 9A-9C, persons skilled in the art will understand that any system configured to perform the method steps, in any order, is within the scope of the invention.

Method 1200 begins at step 1210 where display device 110 receives a panel self-refresh exit request. At step 1210, display device 110 is currently operating in a panel self-refresh mode where video signals generated by SRC 220 from pixel data in frame buffers 224 are used to drive LCD device 216. At step 1212, display device 110 monitors the video signals generated by SRC 220 to detect when the video signals generated by SRC 220 are in a horizontal blanking period. When the video signals generated by SRC 220 are in the horizontal blanking period, display device 110 proceeds to step 1214. At step 1214, display device 110 compares a first pixel location associated with the video signals generated by GPU 240 to a second pixel location associated with the video signals generated by SRC 220. If the difference between the first pixel location and the second pixel location is less than or equal to a trigger distance, then display device 110 proceeds to step 1216, where display device 110 delays the horizontal blanking period in the video signals generated by SRC 220.

At step 1218, display device 110 monitors the video signals generated by GPU 240 to detect a falling edge of an HSync signal. When display device 110 detects the falling edge of the HSync signal associated with the video signals generated by GPU 240, display device 110 proceeds to step 1220, where display device 110 transitions control for driving LCD device 216 from SRC 220 to GPU 240 and method 1200 terminates.

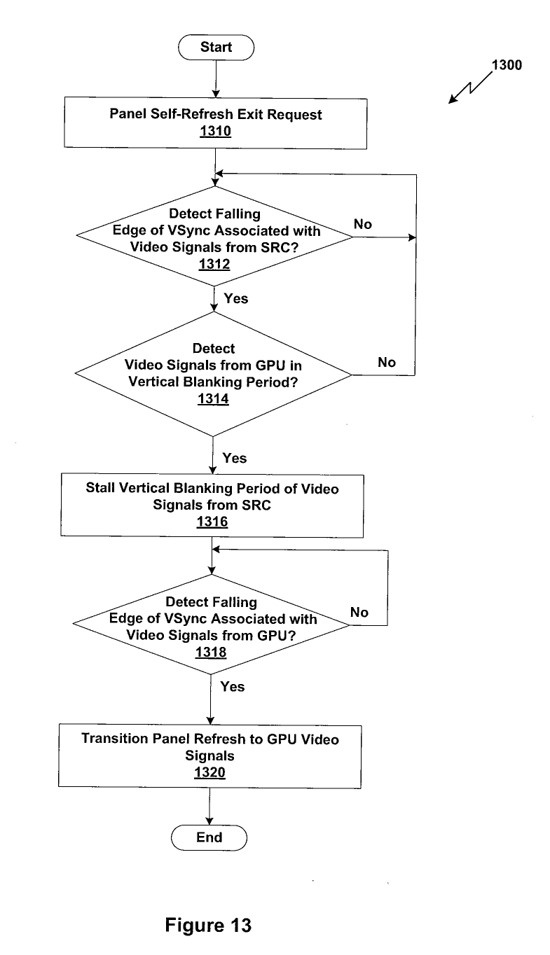

FIG. 13 sets forth a flowchart of a method 1300 for re-synchronizing the video signals generated by GPU 240 with the video signals generated by SRC 220, according to another embodiment of the present invention. Although the method steps are described in conjunction with the systems of FIGS. 1, 2A-2D, 3-7, and 9A-9C, persons skilled in the art will understand that any system configured to perform the method steps, in any order, is within the scope of the invention.

Method 1300 begins at step 1310 where display device 110 receives a panel self-refresh exit request. At step 1310, display device 110 is currently operating in a panel self-refresh mode where video signals generated by SRC 220 from pixel data in frame buffers 224 are used to drive LCD device 216. At step 1312, display device 110 monitors the VSync signal associated with video signals generated by SRC 220 to detect a falling edge of the VSync signal. When display device 110 detects a falling edge of the VSync signal, display device 110 proceeds to step 1314. At step 1314, display device 110 determines whether the video signals generated by GPU 240 are in a vertical blanking period. If the video signals generated by GPU 240 are in the vertical blanking period, then display device 110 proceeds to step 1316, where display device 110 delays the vertical blanking period in the video signals generated by SRC 220.

At step 1318, display device 110 monitors a VSync signal associated with the video signals generated by GPU 240 to detect a falling edge of the VSync signal. When display device 110 detects the falling edge of the VSync signal, display device 110 proceeds to step 1320, where display device 110 transitions control for driving LCD device 216 from SRC 220 to GPU 240 and method 1300 terminates.

In sum, the disclosed technique manages the transition of control for generating the video signals that drive the display device between a graphics controller and a self-refresh controller local to the display device. When the graphics controller detects a first level of idleness in the video frames being generated for display, the graphics controller signals the display device to wake-up a local frame buffer and enter self-refresh mode. The display device caches one or more static frames of video in the local frame buffer for use by the self-refresh controller for generating the video signals used to drive the display device while in self-refresh mode. The graphics controller may then enter a power saving state, where one or more portions of the graphics controller are turned off. When an application executing on the computer system attempts to update the image being displayed, the computer system instructs the graphics controller to wake-up, and the graphics controller sends a request to the self-refresh controller to resynchronize the video signals generated by the self-refresh controller with the video signals generated by the graphics controller. Once the video signals are synchronized, the display device may, once again, be driven by the video signals generated by the graphics controller.

One advantage of the disclosed technique is that the transition of control for generating the video signals used to drive the display device is managed such that the video signals generated by two separate sources are aligned at the point of transition. In so doing, the pixel data represented by the video signals generated by either the graphics controller or the self-refresh controller are consistently displayed at the correct pixel locations of the display device. Consequently, the occurrence of image artifacts in the video frames displayed via the display device is reduced.

While the foregoing is directed to embodiments of the invention, other and further embodiments of the invention may be devised without departing from the basic scope thereof. For example, aspects of the present invention may be implemented in hardware or software or in a combination of hardware and software. One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the present invention, are embodiments of the invention.

In view of the foregoing, the scope of the invention is determined by the claims that follow.

What is claimed is:

1. A method for transitioning control for driving a display device from a local controller included in the display device to a graphics processing unit, the method comprising:
transmitting a panel self-refresh exit request and a first frame of display data to the display device;
monitoring the display device for a period of time to detect that the display device has exited a panel self-refresh mode; and
in response to the display device exiting the panel self-refresh mode, transmitting one or more additional frames of display data to the display device for display.

2. The method of claim 1, wherein the step of monitoring comprises:
monitoring a communications channel between the graphics processing unit and the display device to detect an interrupt request issued by the display device; and
determining that the display device has not issued an interrupt request during that period of time.

3. The method of claim 1, wherein the period of time equals the time required for the display device to receive the first frame of display data, once transmitted.

4. The method of claim 1, wherein the display device, during the period of time, is configured to re-synchronize a video signal generated by the graphics processing unit to a video signal generated by the local controller.

5. The method of claim 4, wherein the display device is configured to stretch a blanking period of the video signal generated by the local controller to ensure that a refresh rate associated with the video signal generated by the graphics processing unit is faster than a refresh rate associated with the video signal generated by the local controller.

6. The method of claim 4, wherein the display device re-synchronizes the video signals by restarting refresh operations from a pixel location associated with the video signal generated by the graphics processing unit.

7. The method of claim 4, wherein the display device re-synchronizes the video signals by transmitting a synchronization signal to the graphics processing unit that indicates when the video signal generated by the local controller is in a vertical blanking period, and wherein the graphics processing unit is configured to align the video signal generated by the graphics processing unit to the synchronization signal.

8. The method of claim 4, wherein the display device re-synchronizes the video signals by:
detecting a horizontal boundary associated with the video signal generated by the local controller;
comparing a first pixel location associated with the video signal generated by the graphics processing unit with a second pixel location associated with the video signal generated by the local controller;
determining whether a difference between the first pixel location and the second pixel location is less than a trigger distance; and
if the difference is greater than the trigger distance, then driving the display device with the video signal generated by the local controller and repeating the steps of detecting, comparing, and determining at the next horizontal boundary of the video signal generated by the local controller, or
if the difference is less than or equal to the trigger distance, then delaying the horizontal blanking period of the video signal generated by the local controller until the video signal generated by the graphics processing unit is aligned with the video signal generated by the local controller.

9. The method of claim 4, wherein the display device re-synchronizes the video signals by:
detecting a vertical boundary associated with the video signal generated by the local controller;
determining whether the video signal generated by the graphics processing unit is in a vertical blanking period; and
if the video signal generated by the graphics processing unit is not in the vertical blanking period, then driving the display device with the video signal generated by the local controller and repeating the steps of detecting and determining at the next vertical boundary associated with the video signal generated by the local controller, or
if the video signal generated by the graphics processing unit is in the vertical blanking period, then delaying the vertical blanking period of the video signal generated by the local controller until the video signal generated by the graphics processing unit is aligned with the video signal generated by the local controller.

10. An apparatus for transitioning control for driving a display device from a local controller included in the display device to a graphics processing unit, the apparatus comprising:
a graphics processing unit configured to:
transmit a panel self-refresh exit request and a first frame of display data to the display device;
monitoring the display device for a period of time to detect that the display device has exited a panel self-refresh mode; and
in response to the display device exiting the panel self-refresh mode, transmitting one or more additional frames of display data to the display device for display.

11. The apparatus of claim 10, wherein the step of monitoring comprises:
monitoring a communications channel between the graphics processing unit and the display device to detect an interrupt request issued by the display device; and
determining that the display device has not issued an interrupt request during that period of time.

12. The apparatus of claim 10, wherein the period of time equals the time required for the display device to receive the first frame of display data, once transmitted.

13. The apparatus of claim 10, wherein the display device, during the period of time, is configured to re-synchronize a video signal generated by the graphics processing unit to a video signal generated by the local controller.

14. The apparatus of claim 10, wherein the display device re-synchronizes the video signals by restarting refresh operations from a pixel location associated with the video signal generated by the graphics processing unit.

15. The method of claim 14, wherein the display device is configured to stretch a blanking period of the video signal generated by the local controller to ensure that a refresh rate associated with the video signal generated by the graphics processing unit is faster than a refresh rate associated with the video signal generated by the local controller.

16. The apparatus of claim 14, wherein the display device re-synchronizes the video signals by transmitting a synchronization signal to the graphics processing unit that indicates when the video signal generated by the local controller is in a vertical blanking period, and wherein the graphics processing unit is configured to align the video signal generated by the graphics processing unit to the synchronization signal.

17. The apparatus of claim 14, wherein the display device re-synchronizes the video signals by:
detecting a horizontal boundary associated with the video signal generated by the local controller;
comparing a first pixel location associated with the video signal generated by the graphics processing unit with a second pixel location associated with the video signal generated by the local controller;
determining whether a difference between the first pixel location and the second pixel location is less than a trigger distance; and
if the difference is greater than the trigger distance, then driving the display device with the video signal generated by the local controller and repeating the steps of detecting, comparing, and determining at the next horizontal boundary of the video signal generated by the local controller, or
if the difference is less than or equal to the trigger distance, then delaying the horizontal blanking period of the video signal generated by the local controller until the video signal generated by the graphics processing unit is aligned with the video signal generated by the local controller.

18. The apparatus of claim 14, wherein the display device re-synchronizes the video signals by:
detecting a vertical boundary associated with the video signal generated by the local controller;
determining whether the video signal generated by the graphics processing unit is in a vertical blanking period; and
if the video signal generated by the graphics processing unit is not in the vertical blanking period, then driving the display device with the video signal generated by the local controller and repeating the steps of detecting and determining at the next vertical boundary associated with the video signal generated by the local controller, or
if the video signal generated by the graphics processing unit is in the vertical blanking period, then delaying the vertical blanking period of the video signal generated by the local controller until the video signal generated by the graphics processing unit is aligned with the video signal generated by the local controller.

19. A computer-readable storage medium including instructions that, when executed by a processor, perform the steps of:
transmitting a panel self-refresh exit request and a first frame of display data to the display device;
monitoring the display device for a period of time to detect that the display device has exited a panel self-refresh mode; and
in response to the display device exiting the panel self-refresh mode, transmitting one or more additional frames of display data to the display device for display.

20. The computer-readable storage medium of claim 19, wherein the step of monitoring comprises:
monitoring a communications channel between the graphics processing unit and the display device to detect an interrupt request issued by the display device; and
determining that the display device has not issued an interrupt request during that period of time.

21. The computer-readable storage medium of claim 19, wherein the period of time equals the time required for the display device to receive the first frame of display data, once transmitted.

22. The computer-readable storage medium of claim 19, wherein the display device, during the period of time, is configured to re-synchronize a video signal generated by the graphics processing unit to a video signal generated by the local controller.
